(19) United States
(12) Patent Application Publication
(10) Pub. No.: US 2018/0057018 A1
(43) Pub. Date: Mar. 1, 2018

(54) Glider Guideway System

(71) Applicant: Galen Suppes, Columbia, MO (US)

(72) Inventor: Galen Suppes, Columbia, MO (US)

(73) Assignee: Suppes Family Trust, Columbia, MO (US)

(21) Appl. No.: 15/808,966

(22) Filed: Nov. 10, 2017

Related U.S. Application Data
(60) Provisional application No. 62/097,921, filed on Dec. 30, 2014.
(60) Provisional application No. 62/116,857, filed on Feb. 16, 2015.
(60) Provisional application No. 62/129,261, filed on Mar. 6, 2015.
(60) Provisional application No. 62/158,569, filed on May 8, 2015.
(60) Provisional application No. 62/189,257, filed on Jul. 7, 2015.
(60) Provisional application No. 62/192,490, filed on Jul. 14, 2015.
(60) Provisional application No. 62/204,710, filed on Aug. 13, 2015.
(60) Provisional application No. 62/206,358, filed on Aug. 18, 2015.
(60) Provisional application No. 62/527,446, filed on Jun. 30, 2017.
(60) Provisional application No. 62/432,335, filed on Dec. 9, 2016.
(60) Provisional application No. 62/420,456, filed on Nov. 10, 2016.

(51) Int. Cl. B61B 3/02; B61B 13/08; B61C 13/04; B60L 13/10

(52) U.S. Cl. CPC B61B 3/02; B61B 13/08; B60M 1/305; B60L 13/10; B61C 13/04

(57) ABSTRACT

The Glider Guideway System (also referred to as Terreplane Transportation System) is a ground-based transportation comprised of flying vehicles pulled by a propulsion line. An important design feature of the most preferred system is that the propulsion line only experiences longitudinal forces during flight making low-cost propulsion lines possible. A propulsion carriage engages the propulsion line to create acceleration. The system include novel embodiments for linear motor stators that travel on cable guideways, a method to connect cable guideways without obstructing the path of the linear motor stators, suspended post embodiments that reduce propulsion line tension and reduce required support tower heights, and novel open loop coils for use with cable guideway armatures.

### CROSS REFERENCE TO RELATED APPLICATIONS

This application is a continuation-in-part of Provisional Applications Ser. No. 62/420,456 filed Nov. 10, 2016 entitled “Terreplane Transportation System”, Ser. No. 62/432,335 filed Dec. 9, 2016 entitled “Open-Sided Coil Devices”, Ser. No. 62/527,446 filed Jun. 30, 2017 entitled “Guideway with Suspended Post”, Ser. No 62/535,558 filed Jul. 21, 2017 entitled “Terreplane Cable, Bridge, and Tension Release”, and U.S. application Ser. No. 15/204,345 filed Jul. 7, 2016, which is a national phase entry under 35 U.S.C. .sctn. 371 of PCT application no. PCT/US2015/067799 filed Dec. 29, 2015, which claims benefit of priority to U.S. Provisional Applications Ser. No. 62/097,921 filed Dec. 30, 2014 entitled “Terreplane-(Transit System)”; Ser. No. 62/116,857 filed Feb. 16, 2015 entitled “Energy Saving Inventions”, Ser. No. 62/129,261 filed Mar. 6, 2015 entitled “Energy Saving Inventions”; Ser. No. 62/158,569 filed May 8, 2015 entitled “Terreplane System Plus”; Ser. No. 62/189,257 filed Jul. 7, 2015 entitled “Terreplane System Plus”; Ser. No. 62/192,490 filed Jul. 14, 2015 entitled “Terreplane System Coils”; Ser. No. 62/205,710 filed Aug. 15, 2015 entitled “Terreplane System”; and Ser. No. 62/206,358 filed Aug. 18, 2015 entitled “Energy Related Inventions”. All of the above-listed applications are incorporated by reference in their entirety herein.

### FIELD

The present invention relates to transportation systems. More specifically this invention relates to a ground-based transportation system with vehicles that attain aerodynamic lift and do not require a rail or road.

### BACKGROUND

This invention is on embodiments of a Terreplane Transit System (aka Terreplane). The following are characteristics of preferred embodiments: a) the vehicles are connected to an overhead propulsion carriage that propels along a stationary propulsion line, b) at least half of vehicle weight is supported by aerodynamic lift (combinations of impact momentum and Bernoulli-type lift), and c) a guideway to support vehicle weight (separate from the propulsion line) is not necessary due to the aerodynamic lift on the vehicle. Targeted travel velocities are from 90 to 500 miles per hour.

Traditional rail tracks and highways are often made of concrete or steel designed to support and guide trains or individual vehicles that ride over it. The propulsion lines (guideways) of this invention are preferably flexible rather than rigid.

The propulsion lines of the embodiments of this invention are not designed to support the weight of vehicles during normal travel. In certain embodiments the propulsion line may support the weight of a stalled vehicle; however, in supporting the weight of the stalled vehicle the propulsion line may deflect to an extent that is not suitable for the design specifications applicable to higher velocity travel. Terreplane propulsion lines are flexible, preferably where propulsion lines are cable embodiments that can sag to support weight and fully recover to a straight position when the weight is removed.

A primary benefit of the embodiments of Terreplane embodiments is that cable tensile forces are cheap compared to traditional rails or highways.

Terreplane is different than a ski lift or gondola system since the propulsion line of the Terreplane transit system is stationary while the propulsion line of a gondola moves along the direction of travel. The vehicles of Terreplane are able to travel much faster than gondola vehicles since the propulsion line of Terreplane is a relatively straight as compared to the repeated sagging deflection of gondola propulsion lines.

The vehicles of Terreplane are different than air planes or jets because the vehicles are (preferably) pulled along a propulsion line that is indirectly attached to the ground throughout the system.

Terreplane vehicles may be of various lengths. Especially for the shorter 1 to 10 passenger vehicles, more than a third of the vehicle lift is due to momentum of air impacting the front of the vehicle and being deflected downward by downward-facing surfaces on the front of the vehicle (combined with downward moving air filling surfaces on top of the vehicle). This characteristic differentiates the embodiments of the embodiments of this invention from prior art on guideway-based flying vehicles. By maximizing the use of the vehicle front to produce lift, the total drag is minimized.

The vehicles of the embodiment can potentially experience rotation in three dimensions. By standards for aircraft the terms for these rotations are: pitch for nose up or down about a horizontal lateral; yaw as nose left or right about a vertical axis; and roll for rotation about an longitudinal axis running from nose to tail. Pitch increases as the nose moves up relative to the back of the vehicle.

A coordinate system of utility is the Cartesian coordinate system with a longitudinal axis considered horizontal and parallel to the propulsion line at the location of interest, a vertical axis, and a horizontal lateral axis perpendicular to the vertical plane. Cylindrical coordinates are also useful with a longitudinal axis considered horizontal and at the general center-line of the longitudinal body of interest, a radial distance perpendicular to the longitudinal axis, and an angular coordinate in degrees.

Wire rope is critical. It is classified by its cross section where more-robust designs are actually windings of multiple strands. For example, a 7×19 aircraft cable consists of seven 19-wire strands (smaller diameter cables) where six of these strand are wrapped around the seventh cable. An example of an oriented design is a 8×19 cable where two strands from the core which is wrapped by six of the strands; rather than round, the resulting cable would be oval in shape. The flatter surfaces of the oval cross-section define the orientation.

Connections could be installed factory-controlled settings with the cable and low-profile connections wound on reels/spools. Factory-manufactured connections would reduce standard deviations in joint properties and allow rapid installation (including replacement) of guideway cables.

### SUMMARY OF THE INVENTION

The Terreplane transit system is a land-based transportation system that incorporates wingless glider-type vehicles that primarily exert a pulling force on propulsion lines during normal operation. A complete and optimal system includes non-contact linear motor propulsion, inexpensive flexible propulsion lines based on cable strand components, novel propulsion line connection embodiments that leave most of the propulsion line circumference clear of the connector components, suspended-post embodiments that extend the maximum feasible distance between support towers, and methods to prevent the accumulation of tension forces in the propulsion lines.

In a suspension propulsion line configuration, an overhead support cable is connected to the propulsion line with vertical connection cables. The connectors of the cables may connect on the top of the propulsion line or the bottom of the propulsion line.

Connections on steel cable propulsion lines are needed for intermediate support and cable-to-cable connections. The connection preferably leave about 90% of the circumference unobstructed, which for a 38 mm diameter cable leaves 11.9 mm (38 mm×0.1×3.14) of width and unspecified lengths for these connections/supports.

Once sufficiently removed from the cable circumference (e.g. 40 mm), the 11.9 mm thickness of these connections can increase. Base case specifications allow the full dead load (e.g. 298 kg/m) to be transferred from the propulsion line to support cable. Example connections would be 3 metric ton capacity connections at 10 m spacing.

### BRIEF DESCRIPTION OF THE DRAWINGS

FIG. 1 is a illustration of a 2-dimensional coil that can be bent into an open-sided coil with two partial loops.

FIG. 2 is an illustration of an open-sided coil with two longitudinally-spaced partial loops including: a) a coil with one loop, b) a coil with two loops, and c) a coil with one loop as a stator partially encompassing a cylindrical armature.

FIG. 3 is an illustration of open-sided coils with two longitudinally-spaced partial loops including: a) a front view of a coil, b) a top view of a coil, and c) a top view of a coil as a stator partially encompassing a cylindrical armature.

FIG. 4 is an illustration of a three-phase stator of a linear induction motor incorporating three open-sided coils with a ferromagnetic sheath including: a) a top view, b) a longitudinal cross-section showing partial coils, and c) a longitudinal cross-section showing ferromagnetic teeth between coil sections.

FIG. 5 is an illustration of a twisted wire rope where: a) a sacrificial core is surrounded by seven cable strands and b) the sacrificial core is removed with placement of one strand in the center and a hanger coupling clamped around the circumference.

FIG. 6 is an illustration of a three-strand cable embodiment where: a) a sacrificial core is surrounded by three cable strands and b) a hanger is attached through use of retainers bolts with partial removal of the sacrificial core.

FIG. 7 is an illustration of an oriented cable configuration with two metal bands in the core.

FIG. 8 is an illustration of propulsion line prepared by combining tube sections of different materials.

FIG. 9 is an illustration of a method to combine tube sections of different materials.

FIG. 10 is an illustration of a circuit to transmit alternating current power with a single wire including: a) the basic circuit using a supercapacitor and b) a circuit enhanced with an RLC circuit cable of exhibiting a harmonic frequency.

FIG. 11 is an illustration of a suspended post which transmits an upward force from a lower support cable to a pair of upper propulsion lines.

FIG. 12 is an illustration of a suspended post embodiment where the support cable proceeds below a water surface and floats support part of the weight of the support cable.

FIG. 13 is a crossbar and suspended post connected at multiple points to a support cable in a configuration that allows tensile forces of propulsion lines of travel in opposite directions to reduce the accumulation of tensile forces in the propulsion lines.

FIG. 14 is an illustration of suspension line configuration using diagonal cables to transfer tension for the propulsion line to a support cable.

FIG. 15 is an illustration of intermediate support cables on a suspension line embodiment.

FIG. 16 is an illustration of a metal band and spacers under a propulsion line to reduce sag.

FIG. 17 is an illustration of two hanger connectors that connect to the propulsion line on the under-side of the propulsion line.

FIG. 18 is an illustration of a Terreplane vehicle with lift forces on the vehicle front, lower vehicle lift surfaces, and back wings or flaps where a balancing downward force acts on the center of gravity.

FIG. 19 is an illustration of simplified force (straight arrows) and torque (curved arrows) balances on a Terreplane vehicle.

FIG. 20 is an illustration of the use of a vehicle's vertically-extended arm connection to allow both ends of the connection arm to be in the same horizontal plane as the propulsion line.

FIG. 21 is an illustration of a propulsion carriage with two open-sided tubes with slots facing outward and opposite.

FIG. 22 is an illustration an open-sided coil showing a triangle-cross-section propulsion line and dashed line for wire of a coil.

### DESCRIPTION OF INVENTION

A Terreplane vehicle is pulled by (attached to) a propulsion carriage that runs on a line; a line often referred to as a propulsion line. Preferably, the propulsion carriage and propulsion line form a linear motor. The preferred propulsion carriage comprises a short stator that partially surrounds a propulsion line armature where a longitudinal slot allows the stator to pass by hanger connectors that support the weight of the armature. Key components of this stator are open-sided electromagnet coils.

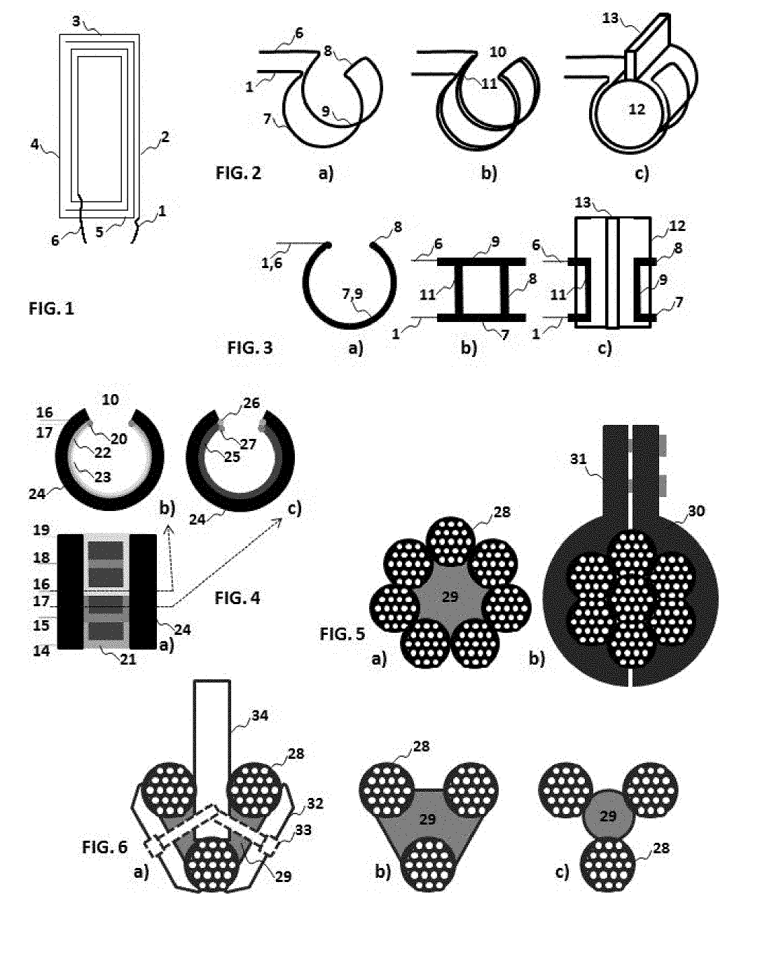

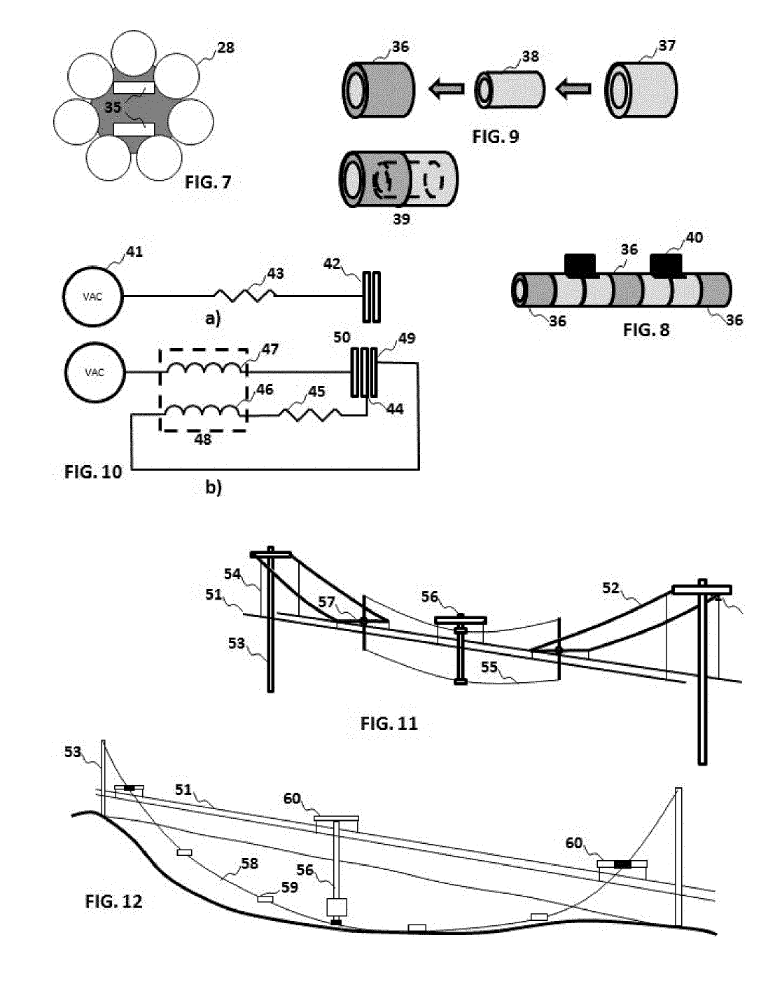

Open-Sided Coil Embodiments—An open-sided coil can be described by a method to make the open-sided coil consisting of a) winding a coil on a flat surface as illustrated by FIG. 1 comprising a connection wire 1, a first side 2, a first end 3, a second side 4, a second end 5, and a circuit-closing connection wire 6 and b) wrapping the flat coil around 55% to 95% (more preferably 70 to 80%) of the circumference of a tube such that wires of the first side land second side 4 wrap around the circumference forming two sets of open-sided loops and the first end 3 and second end 5 run longitudinally along the circumference of the tube.

This FIG. 1 open-sided coil can be described as producing two magnetic coils/fields along the same cavity where the coils have opposite pole orientations. It forms a “left coil” from the wires of the second side 4 and a “right coil” from the wires of the first side 2.

FIG. 2a illustrates a single-wire coil formed by wrapping a single loop of the FIG. 1 coil around a cylinder where side 2 becomes a first partial loop 7 and end 3 becomes a longitudinal connecting wire 8 form the first partial loop 7 to a second partial loop 9. FIG. 2b illustrates how a flat coil for two loops of the FIG. 1 results in the formation of a slot 10 with the second end 5 of the flat coil becoming a longitudinal connection 11 from the second partial loop 9 to the first partial loop 7. FIG. 2c illustrates how a cylinder core or armature 12 fits in the open-sided coil allowing a connector 13 to fit through the slot 10 with free longitudinal movement of the open-sided coil along the connector 13 and armature 12. FIG. 3a in an end view of the open-sided coil of FIG. 2b, FIG. 3b is a top view of the open-sided coil of FIG. 2b, and FIG. 3c is a top view of the open-sided coil and armature 12 of FIG. 2c.

The two loops 7,9 of the FIG. 2 open-sided coil have opposite poles. Synchronizing of the distance between the two opposite-pole open-sided coils with the spacing of conductive sections in the propulsion line is critical design parameter that relates frequency of an AC voltage to a synchronized travel velocity.

The efficiency of the thrust generated from this coil will be a stronger function of velocity than that of a single coil. The slot 10 of the open-sided coil distinguishes the open-sided coil from conventional electromagnetic coils.

To a first approximation, the FIG. 3 open-sided coil will not lead to increased thicknesses of the coil windings (radial thickness relative to a longitudinal center line in the propulsion line) as can occur with other methods of making an open-sided coil.

FIG. 4a illustrates cross sections of a three-phase configuration of three open-sided coils comprising: a first connection wire for a first coil 14, a first connection wire for a second coil 15, a first connection wire for a third coil 16, a second connection wire for the first coil 17, a second connection wire for the second coil 18, and a second connection wire for the third coil 19. The FIG. 4b cross section shows the second coil connection wires 20. The first coil 21 windings 22 are under the third coil windings. A sheath 24 around the open-sided coils can improve linear motor performance. Ferromagnetic teeth 25 (FIG. 4c) can further improve performance. The preferred materials for the teeth 25 and sheath 24 is ferromagnetic. The cross section of FIG. 4b shows the longitudinal connection wires 26, 27 of the first and second open-sided coils. The three open-sided coils are preferably evenly spaced along the longitudinal sheath and operated at 120 degrees of phase between the coils.

For the configuration of FIG. 41, the first partial loop 7 is one of a plurality of first partial loops that form a first partial toroidal coil having an inner toroidal radius and an outer toroidal radius and the second partial loop 9 is one of a plurality of second partial loops that form a second partial toroidal coil having inner and outer toroidal radii equal to the inner and outer radii of the first partial toroidal coil.

Cable and Cable-Armature Embodiments—In the preferred embodiment an open-side coil short stator runs along a longitudinally-extending wire rope armature to provide propulsion. At support points along the cable armature, preferably, most of the cable armature circumference remains relatively constant with a connector obstructing only a minor part of the circumference. A sacrificial core embodiment allows cable armatures of this type to be manufactured.

FIG. 5a illustrates a wire rope of multiple strands 28 that twist around a sacrificial core 29. An example material for a sacrificial core is a thermoplastic polymer. At connection locations the core 29 can be partially or totally removed. When removing the core, one or more of the strands may be positioned in the center. With the sacrificial core removed, the resulting cable has a reduced diameter. A connector 30 may be placed around this reduced-diameter section to produce an overall diameter similar to the cable prior to removal of the sacrificial core 29. The neck 31 of the clamp is a narrow section attaching the cylindrical clamp section to structural parts (not shown) of the clamp for fastening the clamps to supports. The neck width (horizontal distance of FIG. 5 and FIG. 6) is a critical design feature that impacts the design of carriages that travel along the wire rope.

Sacrificial Core Cables A 6×19 poly core cable has a similar appearance as a 7×19 cable where the former has a polymer core (e.g. polypropylene). Inner materials such as thermoplastic polymer foams could be light-weight sacrificial fillers in these cables. For example, a 50 mm cable with a 32 mm thermoplastic polymer foam core would have a similar tensile strength as a 38 mm cable without polymer foam filler. Heat and force can be applied to the 50 mm cable to reduce the diameter by squeezing out gases and/or the melted polymer from the foam core resulting in a lower diameter cable to which traditional clamps can be applied.

FIG. 6a illustrates an alternative sacrificial core configuration where the three strands 28 are in a triangular configuration comprising a first strand, second strand, and third strand; where a first retainer bracket 32 presses (for example, with a bolt 32) the second strand against a hanger 34 connector where the hanger connector 34 is inserted between the first strand and the second strand, the first retainer bracket presses the third strand against a second retainer bracket, the first retainer bracket is secured to the hanger connector at a location between the second strand and the third strand, the second retainer bracket presses the first strand against the hanger connector, the second retainer bracket presses the third strand against the first retainer bracket, the second retainer bracket is secured to the hanger connector at a location between the first strand and the third strand, and a plurality of longitudinally-aligned hanger connectors connect to the wire rope propulsion line.

In a more-generic description, a wire rope guideway 51 is comprised of a plurality of longitudinally extended strands 28, at least one longitudinally extended flexible strip 29, and a plurality of longitudinally aligned connectors 30; comprising a radial coordinate dimension in a plane perpendicular to the longitudinal direction of the armature and extending from the geometric center of the wire rope guideway, where: the strands 28 at least partially surround the flexible strip 29 forming a wire rope with a constant circumference where the circumference contacts and is contained within a maximum wire rope radius, the flexible strip 29 comprising a compressive strength resisting radially inward forces where at least part of flexible strip is removed at locations where connectors are attached, the connectors 30 connected to and support the wire rope guideway, connector assemblies (comprising the connectors, strands 29, and any items used in attaching the connectors to the wire rope), parts of the flexible strip 29 are removed to create volumes for attaching the connectors 30, and at locations where connectors connect to the wire rope at least seventy percent (70%) of connector is contained in a continuous circumference within the maximum wire rope radius.

The sacrificial core 29 may be molded to conform to a close fit to the strands (FIG. 6b), may be substantially cylindrical (FIG. 6c), or any of a rage of geometries that provide a needed resistance to radial compressive forces needed for propulsion.

At the end of cable sections, sections of sacrificial core could be removed and bonding methods performed on the exposed inner surfaces to attach to cable-to-cable connectors. At cable ends and with removal of the core, the load-bearing strands could be wound differently and specifically for good connections to factory-installed end-to-end connectors—all preserving good outer diameter specs and without obstruction of 90% of the circumference.

Factory-installed connections to the cables would enhance quality and literally allow a mile of propulsion line to be rolled from a reel, ready to clip onto support structures. The upgrading of large sections of propulsion line could be performed overnight with easy recovery and recycle of the old propulsion line.

Steel tape 35 (see FIG. 7) can be used as the core material. Use of two face-to-face metal tapes in the core of the cable could cause the cable to arch (e.g. arch upward) if the length of one of the metal tapes is slightly more than the other. An elastic polymer layer between the two metal strips would provide a place for systematic bending of the longer metal tape if a tension is applied causing the natural arch to allow reversible straighten of the cable. The force creating the arch could be oriented to counter the weight of the cable. In this approach, the 3 mm drop in cable that occurs over 6 meters at 10% of nominal tension could be eliminated. For example, connection points could be spaced at 20 to 50 meters while meeting the 3 mm drop specification. Sequential (end-to-end) arching of the steel tape in a polymer core, where a polymer foam core elastically/reversibly preserves the arch is a preferred configuration in this embodiment.

The wire rope may be made of materials other than wire, especially if a carriage with wheels runs along the wire rope instead of a short stator. Cables (or wire rope) are suitable for use with wheel-based propulsion which has a demonstrated performance history with aerial trams. Preferred to wheel-based propulsion is the use of linear motors where electromagnets on the propulsion carriage would wrap around reactive elements in the cable. The reactive elements in the cable would be an outer conductive layer such as strands (or a shell) of copper or aluminum. Repulsive force induced in the copper/aluminum would provide forces for propulsion (longitudinal force) as well as a radial-force (levitation) around the propulsion line cable (i.e. a magnetic bearing).

As part of a linear motor, the propulsion line 51 is optionally comprised of longitudinally discontinuous sections of ferromagnetic material. As the open-sided coil approaches (or partially surrounds) a section of ferromagnetic material (of similar cross-section as the cavity in coil) the magnetic forces pull the material into the coil. As the coil approaches a ferromagnetic section of the propulsion line, the current in the coil causes a magnetic field to pull the ferromagnetic material toward the longitudinal center of the coil creating a pulling force on the propulsion line 51. To prevent a “braking” force, the current in the coil is terminated before the ferromagnetic section reaches the center of the coil.

The most preferred use of the open-sided coil is in a linear induction motor where electromagnets are operated at an alternating frequency generally above 50 Hz and typically from 200 to 900 Hz. The most-preferred cable armature has an outer layer of a conductive material like aluminum and an inner layer of ferromagnetic material like ferromagnetic steel. The layering may be layers of wires, layers of strands, or coatings. The preferred thickness of the aluminum layer is between about 0.08 and 0.2 inches.

The FIG. 6 wire rope propulsion line sacrificial core 29 may be a flexible strip that is an insulator to electron flow and at least one of the strands 29 is connected to a voltage source. This configuration preferably uses straight strands along the armature as opposed to twisting strands. The configuration requires the use of retainers 32 and hanger 34 of materials resistant to conducting electricity.

The most-preferred embodiments transmit electrical power in the strands of a cable armature, and this is transferred to the propulsion carriage using sliding or rotating electrical contacts. In flight, the carriage is not grounded, and so, conventional technology dictates that a minimum of two conducting wires and two sliding/rotating contacts are needed.

FIG. 10 is an embodiment that transfers alternating current with a single wire. Sliding/rotating contacts connect with a VAC source 41 connecting the source to a plate of a capacitor 42 (a plate is a conductive area in a capacitor performing as a large surface area but is not necessarily of a plate geometry) which is able to give up and take electrons based on the plates 42 charge state. This small current may power a load 43. At 60 Hz, the efficiency increases as frequency increases.

The effectiveness of a single-wire transfer can be increased when the transfer is coupled with a circuit that is out of phase with the VAC source 41, preferably 180 degrees out of phase. An example circuit that can operate in a harmonic mode is comprised of a second capacitor plate 44 coupled with a load 45, coil 46 that is optionally coupled with a coil 47 in line with the VAC source 41, and a third capacitor plate 49 that is coupled with the second capacitor plate 44. The load may be an armature coupled with one or both of the coils 46,47 rather than a specific resistor in the circuit.

An alternative hybrid propulsion line embodiment has both sections of ferromagnetic (or magnetic) and conductive (non-ferromagnetic) material. The ferromagnetic sections are used to provide attractive propulsion force while the conductive sections are used to provide strong repulsive forces between the inner partial coil on the carriage and the propulsion line 51. The propulsion carriage (for use with hybrid propulsion line) contains multiple open-slot electromagnets to provide the ability to pull toward ferromagnetic (or magnetic) sections of the propulsion line or to repel way from conductive sections of the propulsion line. The strongest attraction-based propulsion uses ferromagnetic or magnetic (hereafter F/M) sections of length about equal to the length of the electromagnet with spacing between F/M sections about equal to the length of the magnet. The open-sided coil magnet turns on when the center of the open-sided coil is about half way between F/M sections and turns off when in the middle of a F/M section. Conductive sections of the propulsion line may be arranged to allow alternating current to be applied to carriage's open-sided coil to provide levitation without propulsion. Also, the addition of a conductive section between the F/M sections adds to the force forward.

Suspended-Post Embodiment—In some embodiments it is preferred to use a support cable that that dips/sags between posts (like the structural cable of a suspension bridge) where the propulsion line 51 is connected to the support cable 52 in a manner that maintains a relatively straight propulsion line.

FIG. 11 illustrates an embodiment where the support cable 52 sags below the propulsion lines 51. One or more support cables 52 are supported at the top of the towers 53 as in a standard suspension propulsion line (suspension guideway) embodiment. The support cable 52 connects to a merging coupling 57 that keeps the space support cables 52 as the pair contacts the coupling 57. Emerging from the coupling 57 a first converged cable 55 and optional second converged cable continue in a longitudinal path that does not intersect the vehicle travel paths (e.g. a path aligned with the support towers). This lower support cable(s) 55 supports the load of a suspended tower 56 with a cross bar 60 that extends over the vehicle travel path. Connectors connect crossbar 60 to the propulsion lines 51, and a bracket connects the suspended post 56 to the support to the support cable 55 at a location below the propulsion lines. This embodiment allows the use of shorter towers 53.

The converged cables 55 may be of different lengths between the couplings 57. The suspended tower 56 and/or crossbar 60 may be anchored to the ground with cables to reduce movement.

Each of the converged cables 55 may be a continuation of one of the upper pair to support cables 52 where the coupling 57 guides and spaces the cables. Alternatively, cables may clamp onto the coupling 57 and end at the coupling.

Preferably, when the support cables 52 are above the propulsion line, vertical connection cables 54 connect the support cable to the propulsion line. When the support cables 55 are below the propulsion line the weight of the propulsion line is indirectly supported by the support cable 55 through connection cables that connect the propulsion line to the crossbar 60 of the suspended tower 56.

For bridges over water, the support cables 58 may extend below the water surface (see FIG. 12). Under the water surface, buoyant material (e.g. floats) 59 may be attached to the cable to support at least some of the weight of the cable. In this configuration, the submerged support cable may extend for considerable distances (miles) since the weight of the cable is a primary factor that limits the spacing of towers 53. This approach can be used to build bridges over expanses of several miles across water. The submerged cables could be put in trenches of floor bottom dirt in shallow water as a means to protect against being hit by objects in the water. Floats may be attached to suspended towers to facilitate keeping the towers vertical and to provide for additional buoyancy to support temporary weight of stalled vehicles.

As an alternative to forming a tower and crossbar that form a “T” shape, the crossbar may be at the top of a quadrangle that is outside the vehicle travel paths where the bottom of the quadrangle is connected to one or more support cables 55.

Alternative to a converged cable 55 going between vehicle paths, the support cables 52 can be diverged (further apart) to go on the outside of the vehicle paths and support suspended quadrangle supports with cross bars 60.

In a more-generic suspended post embodiment of a transportation system comprises: a pair of horizontally-aligned cable propulsion lines of opposite travel direction along a longitudinal route, a support cable along a vertical plane where vertical plane is parallel to the cable propulsion lines, a horizontal crossbar perpendicular to the vertical plane and connected to the pair of cable propulsion lines by a pair of connectors, and a suspended post that is connected to the horizontal crossbar and support cable. The crossbar supports a portion of the weight of the cable propulsion lines, the suspended post supports the weight of the crossbar and the portion of the weight of the cable propulsion lines, and the support cable supports the weight of the suspended post, the weight of the crossbar, and the portion of the weight of the cable propulsion lines.

Preferred when the support cable 52 sags below the cable propulsion lines 51 is a configuration where the suspended post 56 connects to the support cable 55 at a location below the cable propulsion lines 51, and the suspended post 56 is vertical.

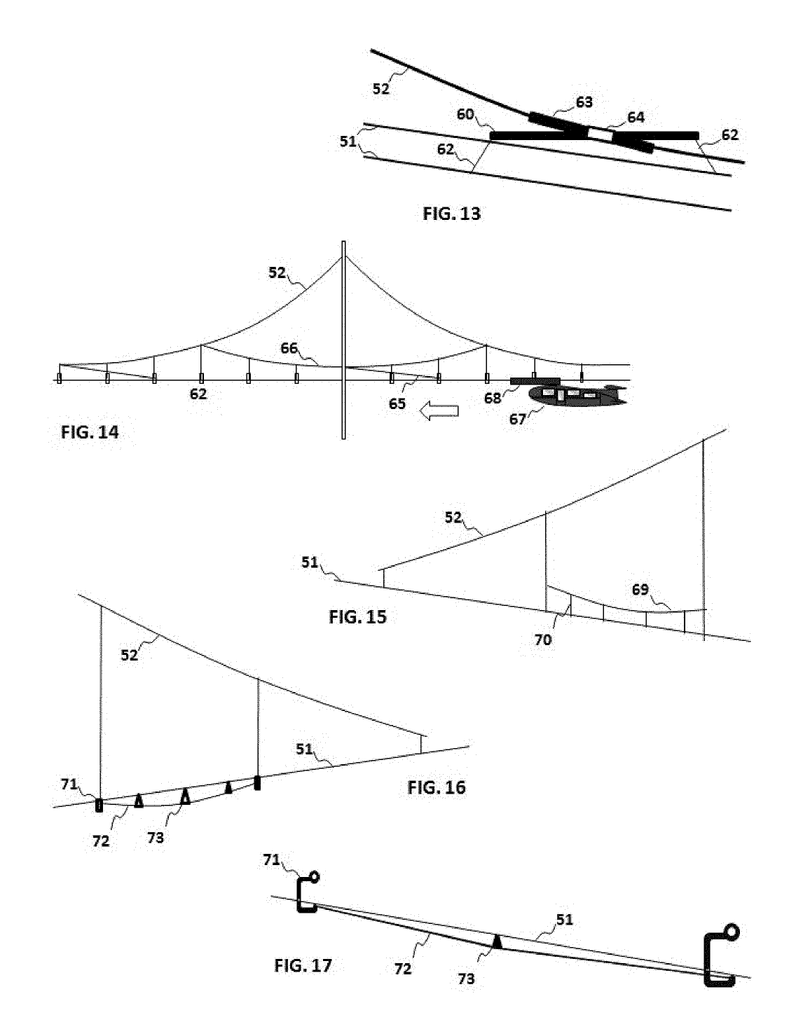

Preferred when the support cable 52 is in close vertical proximity to the transportation line 51 is the suspended post of FIG. 13 where the suspended post extends along the support cable 63 for a distance greater than one fifth the length of the crossbar 60 and is attached to the support cable 63 at multiple locations. Here two vehicle carriages of opposite travel directions exert two tensile forces of opposite directions on the cable propulsion lines, at least part of the tensile forces are transferred to the crossbar by the connectors forming torque forces of oppose direction, the torque forces are transferred from the crossbar to the suspended post, and the torque forces are transferred from the suspended post to the support cable forming tensile forces on the cable.

The most preferred application for the FIG. 13 embodiment is if/where a single support cable attains a minimum position (thus being horizontal) right above and between a pair of transportation lines.

In the absence of the transfer of tension that occurs with the FIG. 13 embodiment, the propulsion forces of consecutive vehicles on a single transportation line would be cumulative and eventually pull the transportation line apart or away from connectors. FIG. 14 illustrates an alternative embodiment for releasing tension from a transportation line where a diagonal line connects the transportation line to the support cable 66 where the diagonal line goes upward in the direction of travel. In this embodiment a vehicle 67 is pulled by a carriage 68 that places a tensile force on the diagonal line. The lower the angle of the diagonal line from the transportation line the more effective the transfer of tensile forces from the transportation line 51.

FIG. 15 illustrates an embodiment to keep the propulsion line from sagging (keep it straight) between connections to the main support cable 52 where a second tier support cable 69 and connection cables 70 are used. One implementation of this embodiment is to attach second tier support cables 69 to connection cables 70 that are connected to either the primary support cables 52 or crossbars 60. Second tier connection cables 70 connect the second tier support cable 69 to the propulsion line 51.

FIG. 16 and FIG. 17 illustrate the use of hangers 71 that attach on the bottom sides of the transportation line. A cable or steel band 72 between the hangers 71 supports spacers 73 that transfer tensile force of the band 72 to an upward force on the support.

For the based case 3 mm drop specification, the 6 meter distance between vertical connection cables can be doubled with the use of tension bands at about 10% of the nominal tensile load of a 38 mm steel wire rope. The band and middle support preferably support half the cable weight for this expanse, which is about 37 kg. If the connection cables and hangers are to support half of the load specifications on the cable, each must support about 3.6 metric tons. This load is half the nominal tensile strength of a 10 mm steel cable.

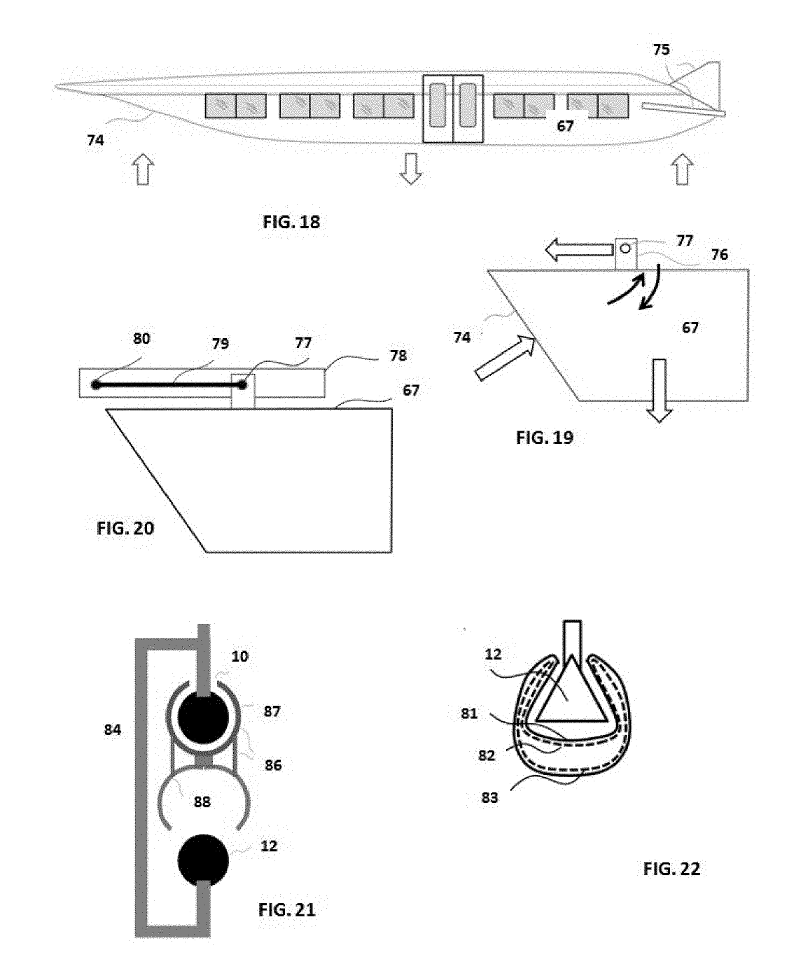

Vertical Force Analysis—FIG. 18 illustrates lift forces on an example vehicle 67 embodiment. The preferred modes of providing lift are momentum impacting the bottom of the vehicle 67 and low pressure forming on the back part of the top of the vehicle. Here, bottom sloping surfaces 74 that slope from the vehicle nose to the support of the vehicle's interior are a most important that air impacts to create aerodynamic lift.—

To promote a passenger compartment of constant cross-section, it is preferred that lift forces focus on the front and back of the vehicle in a manner that leads to zero torque. Flaps 75 on the front (see vehicle nose) and the back of the vehicle allow for fine adjustment of lift with velocity and control of vehicle in response to disturbances such as wind or passenger movement. Similar lift features can be implemented on the propulsion carriage 78 so as to lead to near-zero vertical forces between the propulsion carriage 78 and propulsion line 51.

Longitudinal Force Analysis—It is preferred to have the vehicle 67 travel as close to the propulsion carriage 78 as possible to minimize torque due to longitudinal forces. It is preferred to have the propulsion carriage longitudinally centered on the top of a symmetric vehicle to promote lateral stability.

FIG. 19 illustrates an example simplified torque balance (torques in a vertical plane parallel to the propulsion line) in such a configuration which uses an improved connector arm. An improved connector arm system embodiment has the advantage of a design where near-zero vertical force between the propulsion carriage 78 and the propulsion line 51 is more-easily attainable during flight; however, it can be attained with a single arm.

In this improved connector-arm embodiment as illustrated by FIG. 20, a hinge joint connects the front end of the connection arm 79 to the propulsion carriage by a hinge joint 80. The other end of the connection arm 79 is connected to a vertically-extended vehicle arm connection 76 (hereafter VEAC) by a hinge joint 77. Preferably, during normal flight the propulsion line 51, forward arm hinge joint 80, and back arm hinge joint 77 are in (or nearly in) the same plane.

The hinge joints 80 77 allow the vehicle 67 to swing up to fly or down to load/unload.

FIG. 19 illustrates the force vectors in a base case example during preferred normal flight of the vehicle 67. Key aspects of these base case force vectors are: a) a pulling force vector on the VEAC joint(s) 77 with a cumulative vector superimposed on the propulsion line, b) an air momentum impact vector that pushes back and up on the vehicle 67 on a bottom surface 74, and c) a gravitational force vector through the center of gravity of the vehicle 67. In this base case configuration, the only upward force is on front surfaces of the vehicle. In practice designs allow for more surfaces to be effectively used.

Also, FIG. 19 illustrates a torque balance on the base case force analysis. The line of rotation is the line through the VEAC joint(s) 77. Since the pulling force goes through the line of vehicle rotation, the pulling force of the arms 79 does not produce torque. Preferably the VEAC joint(s) 77 are a single joint, and most-preferably, rather than two hinge joints it is a single hinge joint with a single arm and a single SMPCAH joint 80 on the same side of the propulsion line.

The VEAC joint(s) 77 are located, longitudinally, in front of the center of gravity, and so, gravitational force produces a clockwise torque. The air momentum impact force has a net vector below the VEAC joint(s) 77, and so, the air momentum impact force creates a counter-clockwise torque that balances the torque resulting from gravity. Herein, the preferred embodiment is defined using methods known in the science to create zero net torque about the VEAC joint(s). This base case illustrates how air impact momentum at the front of the vehicle can be transformed to a lifting force for the entire vehicle.

Preferably, SMPCAH 80 are located toward the front of the propulsion carriage 78. Preferably, VEAC are attached to the top of the vehicle and toward the front of the vehicle 67.

In this base case design, there is a velocity specific to a vehicle (surface, weight, and center of gravity) that leads to a horizontal pitch for the preferred flight having near-zero vertical force between the propulsion carriage and the propulsion line. Likewise, there are a range of pitches (pitch of vehicle relative to propulsion line) for which each pitch has a single velocity that leads to near-zero vertical forces on the propulsion line.

Optionally, allow movement of the VEAC joint(s) 77 along this longitudinal dimension of the vehicle to balance torque on the vehicle. The angle of the VEAC joint(s) is preferably controlled to control vehicle pitch.

Switching—A method for a propulsion carriage to switch from a travel guideway to a switch guideway at a switch location where, in the preferred embodiment, the switch guideway is located above the travel guideway. Each guideway has a cross section perpendicular to the travel route. Each cross section has vertical location (point or line of distance) of maximum horizontal width. The surface of the guideway above the vertical location of maximum horizontal width is the upper surface of the guideway and the surface of the guideway below the vertical location of maximum width the lower surface of the guideway.

As the propulsion carriage travels along the route on the travel guideway, at the switch location the entry end of the switch guideway physically is the point where the switch guideway starts (along the route dimension). Starting at the end, the switch guideway's route (starting at the entry end) is approximately parallel to the travel guideway route over a longitudinal distance at the switch location. After the switch location, the path of the switch guideway departs from the path of the travel guideway.

The switch-capable propulsion carriage is comprised of an upper switch guideway engagement mechanism and lower travel guideway engagement mechanism which are capable of engaging the switch guideway and the travel guideway, respectively. The propulsion carriage achieves a switch by engaging the switch engagement mechanism with the switch guideway.

A preferred upper switch engagement mechanism is comprised of a suspension means of interaction such as at least one pair of wheels or pair of electromagnet ends. The propulsion carriage performs the switch maneuver when the upper switch engagement mechanism travels above the upper surface of the switch guideway at the start of the switch guideway. In this switch maneuver, the upper switch engagement mechanisms engage the switch guideway and takes the carriage along the route of the switch guideway. For example, the pair of wheels are above the upper surface of the switch guideway and roll/run on that upper surface.

Alternatively, when the upper switch engagement mechanisms are below the lower surface of the switch guideway, the propulsion carriage fails to engage the switch guideway and travel proceeds along the (default) travel guideway. For example, the upper pair of wheels of the propulsion carriage are below the lower surface of the switch guideway and do not engage (roll on) any surface.

A controlled engaging of the switch guideway is achieved by controlling the distance between the upper switch engagement mechanism and the upper surface of the travel guideway which can be achieved by either a) locating/moving the lower travel engagement mechanism further above the upper surface of the lower guideway orb) increasing the distance between the upper switch engagement mechanism and the lower travel engagement mechanism on the propulsion carriage.

Moving the entire carriage further above the lower guideway (travel guideway) can be achieved by moving the wheels of the lower engagement mechanism lower. Alternatively, a travel guideway may have a narrower upper extension and a wider lower part. By engaging the upper extension section the propulsion carriage travels higher while by engaging the lower wider section the propulsion carriage travels lower.

A propulsion carriage may be two propulsion carriages (one on top of the other) connected by at least two arms of equal length at different longitudinal locations such that the arms pivot at joints of attachment to the two carriages. The maximum separation distance is when the arms are perpendicular to the surfaces of attachment.

The switch guideway is preferably above the travel guideway.

One or more arms attach the propulsion carriage to a vehicle. Preferably, if the switch guideway veers to the right of the travel guideway, the arm is connected to the right side (right of path of guideway through propulsion line right of center of gravity) of both the propulsion carriage and the vehicle. (and visa versa).

Preferably, a connection joint on the propulsion carriage is in the same horizontal plane as the propulsion line which the propulsion carriage engages. A connection joint on the vehicle is preferably at a location that can be in the same plane as the propulsion line during normal travel; such a location is above the passenger compartment and most-easily positions as an extension above the passenger compartment.

Joints that are horizontal and perpendicular to the propulsion line allow a continuous arm and joint to keep the vehicle horizontal by positioning the center of gravity below the propulsion line. Preferred joints are hinge joints.

Hinge joints have multiple points of contact along a pin or pins. The points may be on the same or opposite sides of the cavity for propulsion line travel. If on opposite sides of the cavity, a lateral arm may connect the two sides in a manner where rotation of that lateral arm (as corresponding to vehicle movement) does not cross the line of travel of the propulsion line during travel or during switching.

As a safety precaution, when the propulsion carriage travels above the guideway, the wheels and/or casing of the propulsion carriage form a gap below the guideway wider than the support bars but narrower than the widest part of the guideway. This physically prevents derailment. The same analogy applies above the guideway for a propulsion carriage traveling below an upper guideway.

For a switch to occur, either the casing/wheels must widen or the travel guideway must become more narrow. Both are viable options. If the guideway becomes more narrow, the location proximity of the upper guideway to the lower guideway guards against derailment. Alternatively, the widening of the casing/wheels can be physically coupled with the mechanism to engage the upper guideway.

Both the switch and travel guideways may have a narrow configuration at switching locations thus allowing the engaging of the switch guideway to occur by either travel over the entrance end or travel up past the narrow section.

Optionally, the force needed to keep the propulsion carriage 78 in contact with the propulsion line 51 during this switch can be achieved with aerodynamic forced induced by the flaps on the propulsion carriage.

FIG. 21 illustrates a method of switching where the propulsion line cable is part of a propulsion line 51 for a short stator embodiment is represented by the same image as the propulsion line electromagnet for the long stator embodiment. Likewise, an open-sided propulsion carriage tube is illustrated for the long stator embodiment by the same depiction as the open-sided propulsion carriage electromagnet for the short stator embodiment.

In the long stator embodiment, two open-sided propulsion carriage tubes (reactive components) are connected and positioned between two series of propulsion line electromagnets (active components, e.g. electromagnets). At switching locations two series of propulsion line electromagnets “allow for interaction with either of the two open-sided propulsion carriage tubes. The two series of propulsion line electromagnets proceed to different paths in the switch maneuver where the path taken by the propulsion carriage is the switch line.

The preferred method for the switch proceeds to following the switch line in the following sequence: a) only the electromagnets on the switch line are activated (or are activated to a much greater extent than the other line) and b) the open-sided propulsion carriage tube is tightened around the switch line and widened around the opposite line to allow the carriage to be disengaged and separate from the opposite line.

In a short stator embodiment, the open-sided propulsion carriage electromagnet has a slot capable of mechanically widening or narrowing to engage (or disengage) a propulsion line cable to perform a switch. The short-stator switching sequence includes: a) only the open-sided propulsion carriage electromagnet s around the switch active are activated (or are activated to a much greater extent than the other line) and b) the open-sided propulsion carriage electromagnet is tightened around the switch line and widened around the opposite line to allow the carriage to be disengaged and separate from the opposite (non-switch) line.

Generic Open-Sided Coil—FIG. 22 is an end-view of an open-sided coil in the short stator of a propulsion carriage. The inner surface 40 of the tube 38 has a shape such that when the carriage 78 is placed over the propulsion line 51, there is a relatively uniform space between the tube's inside surface 40 of the coil's 37 out surface as illustrated by FIG. 22.

In the general sense, a mold that preserves the shape of a magnetic coil, core, cavity, and slot may be a thermoset polymer that holds the components in place or may be any of a range of mechanical constraints that serves the same purpose. In the general sense, the cavity forms a shell 81 through which an insert 12 passes and the slot forms a path through with connections to the insert pass. More specifically for the embodiments of this invention, the shell 81 and insert 12 engage to form a linear motor. An example of a shell 81 is an open-sided reactive tube 38, and an example of an insert 12 is a propulsion line 51. The shell 81 component of the linear motor may be either on the carriage 78 or the propulsion line 51; and likewise, the insert 12 component may be either on the carriage 78 or the propulsion line 51.

Alternative to widening the slot of the lower tube 88 when the propulsion carriage disengages from the lower line, the width of the lower propulsion line may be reduced adequately to allow the carriage to slip up and away from the lower propulsion line. In this embodiment, the propulsion carriage is preferably designed so the two propulsion lines provide obstruction to derailment by not allowing sufficient vertical movement unless the switch is in progress.

While the previous paragraphs and FIG. 21 are described in terms of upper and lower propulsion lines, the switch can be oriented with horizontal or vertical (or any angle in between) movement to select and engage with a switch propulsion line.

The most preferred configuration for as switch is with a vehicle having a single arm with a hinge joint connection to the propulsion carriage on the side of the carriage opposite the joist 84 used to support and separate the two propulsion lines used during the switch operation. The arm preferably has a hinge joint in a common plane with the propulsion line of FIG. 21 when the carriage engages that lower propulsion line. Also preferred is a hinge joint connection 77 at the upper arm connection point of the FIGS. 19 and 20 vehicle representations.

Linear Motor Propulsion—An alternative open sided coil embodiment is created by flattening a coil of wire and wrapping that flatten coil around a cylinder. FIG. 22 illustrates the resulting open-sided coil with an inner surface 81, an inner partial coil 82, an outer partial coil 83, a cavity, and a slot 10. Longitudinally displacing the outer partial coil 83 from the inner coil 82 produces the open-sided coil of FIG. 2.

The open-sided coil is capable of traveling along or attaching to a propulsion line 51 that has a cross-section that fits within the cavity as illustrated by FIG. 2c. The slot 10 allows connection of the propulsion line to a support structure (e.g. suspension cable). Optionally, the slot allows attachment of the open-sided coil to a propulsion line to form a long stator. The embodiment is not limited to any particular orientation; the slot may be to the side, bottom, or any angle.

The surroundings to a coil are all that is outside the coil, the slot, the two ends of the coil, and a protective surface that encases the open-sided coil for protection and structural needs.

In a broader sense the preferred linear motor comprises an open-sided coil stator that travels along a longitudinally-extending armature of constant circumference comprising: a plurality of longitudinally-aligned armature connectors supporting the weight of the armature, a radial coordinate dimension in a plane perpendicular to the longitudinal direction of the armature with an origin at the geometric center of the armature and an angle having a value of zero for a radially-extending line going through geometric center of the armature connectors, a width dimension equal to the width in a plane perpendicular to the longitudinal direction of the armature and perpendicular to the radially-extending line going through the geometric center of the armature, a plurality of connector necks extending radially outward where said necks have similar neck widths, a maximum armature width that is greater than the said neck widths, a stator cavity extending the longitudinal length of the stator surrounding the armature circumference comprising an inner cavity surface 81 adjacent to the armature circumference, a longitudinally extending stator slot along the cavity where said slot is wider than the said neck widths and narrower than the maximum armature width, and an open-sided electromagnet coil configuration in the stator where at least half the coil is adjacent to the inner cavity surface 81 and extends at least 180 degrees along that cavity wall, where the connector necks pass through the slot as the stator travels along the armature.

1. A linear motor comprising an open-sided coil stator that travels along a longitudinally-extending armature of constant circumference comprising:
a plurality of longitudinally-aligned armature connectors supporting the weight of the armature,
a radial coordinate dimension in a plane perpendicular to the longitudinal direction of the armature with an origin at the geometric center of the armature and an angle having a value of zero for a radially-extending line going through geometric center of the armature connectors,
a width dimension equal to the width in a plane perpendicular to the longitudinal direction of the armature and perpendicular to the radially-extending line going through the geometric center of the armature,
a plurality of connector necks extending radially outward where said necks have similar neck widths,
a maximum armature width that is greater than the said neck widths,
a stator cavity extending the longitudinal length of the stator surrounding the armature circumference comprising an inner cavity surface 81 adjacent to the armature circumference,
a longitudinally extending stator slot along the cavity where said slot is wider than the said neck widths and narrower than the maximum armature width, and
an open-sided electromagnet coil configuration in the stator where at least half the coil is adjacent to the inner cavity surface 81 and extends at least 180 degrees along that cavity wall, where
the connector necks pass through the slot as the stator travels along the armature.

2. The linear motor of claim 1 with the open-sided electromagnetic coil comprising a wire adjacent to the inner cavity surface 81 where the wire forms a sequential path comprising:
a first partial loop 7 traversing between fifty-five (55) and ninety-five (95) percent of the circumference at a first longitudinal position and of a first angular direction,
a longitudinal connection 8 connecting the first partial loop to a second partial loop at a second longitudinal position, and
the second partial loop 9 traversing between fifty-five (55) and ninety-five (95) percent of the circumference at the second longitudinal position of an angular direction opposite the first angular direction.

3. The open-sided coil of claim 2 where
the first partial loop 7 is one of a plurality of first partial loops that form a first partial toroidal coil having an inner toroidal radius and an outer toroidal radius,
the second partial loop 9 is one of a plurality of second partial loops that form a second partial toroidal coil having inner and outer toroidal radii equal to the inner and outer radii of the first partial toroidal coil.

4. The open-sided coil of claim 3 where a ferromagnetic cylinder sleeve 24 having an inner radius and outer radius, where:
the sleeve surrounds the first partial toroidal coil and the second partial toroidal coil,
the inner radius of the sleeve 24 is equal to the outer radii of the toroidal coils, and where a plurality of ferromagnetic teeth 25 project inward from the sleeve 24 to a radius about equal to the inner radii of the toroidal coils with longitudinal and angular dimensions generally filling the space not occupied by the toroidal coils.

5. A wire rope guideway 51 comprising a plurality of longitudinally extended strands 28, at least one longitudinally extended flexible strip 29, and a plurality of longitudinally aligned connectors 30; comprising a radial coordinate dimension in a plane perpendicular to the longitudinal direction of the armature and extending from the geometric center of the wire rope guideway, where:
the strands 28 at least partially surround the flexible strip 29 forming a wire rope with a constant circumference where the circumference contacts and is contained within a maximum wire rope radius,
the flexible strip 29 comprising a compressive strength resisting radially inward forces where at least part of flexible strip is removed at locations where connectors are attached,
the connectors 30 connected to and support the wire rope guideway,
connector assemblies comprising the connectors, strands 29, and any items used in attaching the connectors to the wire rope,
parts of the flexible strip 29 are removed to create volumes for attaching the connectors 30, and
at locations where connectors connect to the wire rope at least seventy percent (70%) of connector is contained in a continuous circumference within the maximum wire rope radius.

6. The wire rope guideways 51 of claim 5 where the flexible strip 29 is comprised of a thermoplastic polymer.

7. The wire rope guideways 51 of claim B1, where:
the strands 28 twist around the flexible strip at longitudinal locations between connectors, and
one of the strands is in the center of the coil forming a center strand at the connectors 30.

8. The wire rope guideways 51 of claim 5 comprised of three strands 28 in a triangular configuration comprising a first strand, second strand, and third strand, where:
hanger connectors are inserted between the first strand and the second strand,
first retainer brackets press the second strand against hanger connectors,
first retainer brackets press the third strand against second retainer brackets,
first retainer brackets are attached to the hanger connectors between the second strand and the third strand,
second retainer brackets press the first strand against the hanger connectors,
second retainer brackets press the third strand against the first retainer brackets, and
second retainer brackets are attached to the hanger connectors between the first strand and the third strand.

9. The wire rope guideways 51 of claim 8 where the flexible strip 28 is an insulator to electron flow and at least one of the strands 28 is connected to a voltage source.

10. The wire rope guideways 51 of claim 1 extended longitudinally along a transit route to form a transit line where wheels apply radial forces on the strands to accelerate a vehicle along the transit line.

11. The wire rope guideways 51 of claim B1 extended longitudinally along a transit route to form a transit line where electromagnets induce longitudinal forces on the strands to accelerate a vehicle along the transit line.

12. A suspended post of a transportation system comprising,
a pair of horizontally-aligned cable guideways 51 of opposite travel direction along a longitudinal route,
a support cable along a vertical plane where the vertical plane is parallel to the cable guideways 51,
a horizontal crossbar perpendicular to the vertical plane and connected to the pair of cable guideways 51 by a pair of connectors,
a suspended post that is connected to the horizontal crossbar and support cable, where
the crossbar supports a portion of the weight of the cable guideways 51,
the suspended post supports the weight of the crossbar and the portion of the weight of the cable guideways 51, and
the support cable supports the weight of the suspended post, the weight of the crossbar, and the portion of the weight of the cable guideways 51.

13. A suspended post of claim 12, where the support cable 52 sags below the cable guideways 51, the suspended post 56 connects to the support cable 55 at a location below the cable guideways 51, and the suspended post 56 is vertical.

14. A suspended post of claim 13 where the suspended post 56 is laterally located between two cable guideways 51.

15. A suspended post of claim 13 where a pair of suspended posts 56 are laterally located on opposite sides of the cable guideways 51 and the two suspended posts 56 are connected to the crossbar.

16. A suspended post of claim 13, where the suspended post extends along the support cable 63 for a distance greater than one fifth the length of the crossbar 60 and is attached to the support cable 63 at multiple locations.

17. A suspended post of claim 16, where two vehicle carriages of opposite travel directions exert two tensile forces of opposite directions on the cable guideways 51, at least part of the tensile forces are transferred to the crossbar 60 by the connectors forming torque forces of oppose direction, the torque forces are transferred from the crossbar 60 to the suspended post, the torque forces are transferred from the suspended post to the support cable forming tensile forces on the cable.

18. A transportation system comprising:
a line that is supported at multiple locations and forms a route for travel of the transportation system,
a propulsion carriage producing a tensile force on the line and accelerating the carriage along the route,
a vehicle connected to the propulsion carriage,
a vehicle fuselage comprising the vehicle without laterally-extending wings,
a vehicle pitch in degrees having a value of zero corresponding to a pitch of minimum aerodynamic drag where positive degrees correspond to lowering the back of the vehicle relative to the front of the vehicle,
a connection joint between the propulsion carriage and the vehicle,
a plurality of aerodynamic vehicle body surfaces that create an aerodynamic lift on the fuselage, where
rotation of the connection joint increases vehicle pitch and increases lift generated by surfaces on the bottom of the vehicle.

19. A transportation system according to claim 18 where the connection joint is a hinge joint.

20. A transportation system according to claim 18 where the connection joint is a first hinge joint connecting the vehicle to a connection arm comprising a second hinge joint connecting the arm to the propulsion carriage.
